(19) United States
(12) Patent Application Publication
(10) Pub. No.: US 2003/0079325 A1
(43) Pub. Date: May 1, 2003

(54) Holding device of belt wheel structure

(76) Inventor: Pi-Liang Wu, Taichung (TW)

Correspondence Address: Pi-Liang Wu, P.O. Box 55-124, Taichung, TW

(21) Appl. No.: 09/984,113

(22) Filed: Oct. 29, 2001

(51) Int. Cl. B25B 27/14

(52) U.S. Cl. 29/281.5

(57) ABSTRACT

The present invention relates to a holding device of a belt wheel structure, including two arm plates, and a connecting member. Each arm plate is pivoted with the connecting member by a locking member. Each arm plate has a first end provided with a fixing snap, and a second end pivoted with a movable snap by a securing member. Each movable snap has a base portion screwed with the securing member, thereby positioning and locking the movable snap on the respective arm plate. The fixing snap is protruded with a snap tooth, and each movable snap is laterally protruded with a snap tooth, so that the snap tooth of the fixing snap may mate with the snap tooth of each movable snap to be inserted into a belt wheel structure for holding and securing the belt wheel structure.

### BACKGROUND OF THE INVENTION

1. Field of the Invention

The present invention relates to a holding device of a belt wheel structure, and more particularly to a holding device that may be used to hold and position belt wheel structures of different sizes, types and specifications without having to prepare holders of different sizes, types and specifications, thereby enhancing convenience of operation and maintenance.

2. Description of the Related Art

A conventional holder 1 of a belt wheel structure in accordance with the prior art shown in FIGS. 1 and 2 has a top end provided with two protruded teeth 2, and a bottom end provided with a protruded tooth 2′. Thus, the holder 1 may be inserted into two opposite belt wheels 8 of a belt wheel structure, whereby the protruded teeth 2 and 2′ may be inserted into and secured in the tooth grooves of the two opposite belt wheels 8, to prevent the two opposite belt wheels 8 from being rotated, thereby facilitating the user replacing the belt 9 of the belt wheel structure.

However, the conventional holder only has a fixed size, and cannot be used to hold and position belt wheel structures of different sizes, types and specifications, so that the user has to prepare multiple holders of different sizes, types and specifications to fit belt wheel structures of different sizes, types and specifications, thereby causing inconvenience of operation and maintenance.

### SUMMARY OF THE INVENTION

The present invention has arisen to mitigate and/or obviate the disadvantage of the conventional holder of a belt wheel structure.

The primary objective of the present invention is to provide a holding device of a belt wheel structure that may be used to hold and position belt wheel structures of different sizes, types and specifications without having to prepare multiple holders of different sizes, types and specifications, thereby enhancing convenience of operation and maintenance.

In accordance with the present invention, there is provided a holding device of a belt wheel structure, comprising: two arm plates, and a connecting member mounted between the two arm plates, wherein:

each of the two arm plates is pivoted with the connecting member by one of two locking members, each of the two arm plates has a first end provided with an upright fixing snap vertical to the arm plate, and a second end pivoted with one of two movable snaps by one of two securing members, each of the two movable snaps is opposite to the fixing snap of each of the two arm plates, each of the two movable snaps has a base portion screwed with each of the two securing members, thereby positioning and locking each of the two movable snaps on the respective arm plate, the fixing snap of each of the two arm plates is laterally protruded with a snap tooth, and each of the two movable snaps is laterally protruded with a snap tooth that is opposite to the snap tooth of the fixing snap of each of the two arm plates, so that the snap tooth of the fixing snap of each of the two arm plates may mate with the snap tooth of each of the two movable snaps to be inserted into a belt wheel structure for holding and securing the belt wheel structure.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a conventional holder of a belt wheel structure in accordance with the prior art;

FIG. 2 is a schematic operational view of the conventional holder of a belt wheel structure as shown in FIG. 1 in use;

FIG. 3 is a perspective view of a holding device of a belt wheel structure in accordance with a first embodiment of the present invention;

FIG. 4 is an exploded perspective view of the holding device of a belt wheel structure as shown in FIG. 3;

FIG. 5 is a schematic operational view of the holding device of a belt wheel structure as shown in FIG. 3 in use;

FIG. 6 is a perspective view of a holding device of a belt wheel structure in accordance with a second embodiment of the present invention;

FIG. 7 is a schematic operational view of the holding device of a belt wheel structure as shown in FIG. 6 in use; and

FIG. 8 is an exploded perspective view of a holding device of a belt wheel structure in accordance with the third embodiment of the present invention.

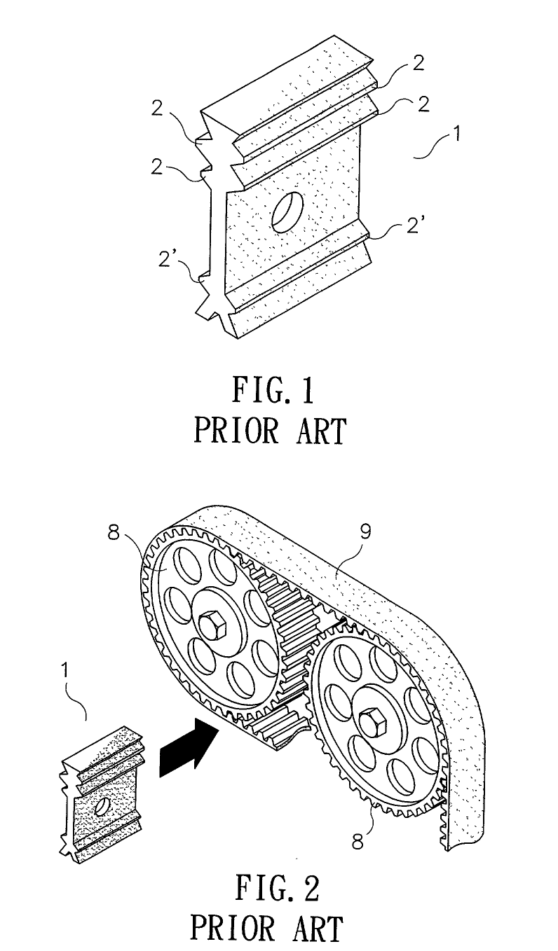

### DETAILED DESCRIPTION OF THE INVENTION

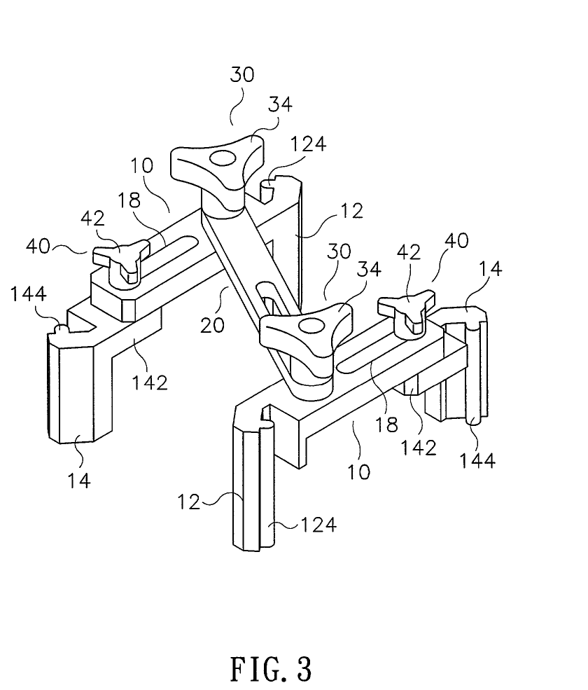

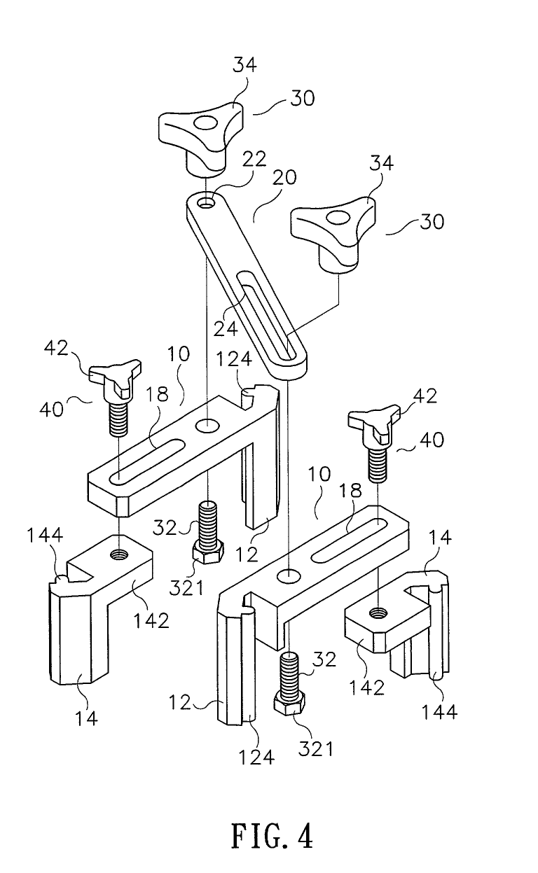

Referring to the drawings and initially to FIGS. 3 and 4, a holding device of a belt wheel structure in accordance with a first embodiment of the present invention comprises two arm plates 10, and a connecting member 20 mounted between the two arm plates 10.

Each of the two arm plates 10 is pivoted with the connecting member 20 by one of two locking members 30. The connecting member 20 is an elongated plate, and has a first end formed with a bolt hole 22 and a second end axially formed with an elongated slot 24.

Each of the two locking members 30 includes a bolt 32, and a rotation cap 34. The bolt 32 is in turn extended through each of the two arm plates 10 and the connecting member 20, and is screwed with the rotation cap 34.

The bolt 32 of each of the two locking members 30 is respectively extended through the bolt hole 22 and the elongated slot 24 of the connecting member 20, so that the connecting member 20 and the two arm plates 10 may be clamped by the bolt head 321 of the bolt 32 and the rotation cap 34 of each of the two locking members 30, thereby positioning the connecting member 20 and the two arm plates 10. The elongated slot 24 of the connecting member 20 may be used to adjust the distance between the two arm plates 10.

Each of the two arm plates 10 has a first end formed or provided with an upright fixing snap 12 vertical to the arm plate 10, and a second end axially formed with an elongated slot 18. One of two securing members 40 is extended through the elongated slot 18 of each of the two arm plates 10, and is pivoted with one of two movable snaps 14. Each of the two movable snaps 14 is opposite to the fixing snap 12 of each of the two arm plates 10. Each of the two movable snaps 14 has a base portion 142 screwed with a first end of each of the two securing members 40. Each of the two securing members 40 has a second end formed with a rotation head 42 which may mate with the base portion 142 of each of the two movable snaps 14 to clamp the respective arm plate 10, thereby positioning and locking each of the two movable snaps 14 on the respective arm plate 10.

The fixing snap 12 of each of the two arm plates 10 is laterally protruded with a snap tooth 124. Each of the two movable snaps 14 is laterally protruded with a snap tooth 144 that is opposite to the snap tooth 124 of the fixing snap 12 of each of the two arm plates 10, so that the snap tooth 124 of the fixing snap 12 of each of the two arm plates 10 may mate with the snap tooth 144 of each of the two movable snaps 14 to be inserted into a belt wheel structure for holding and securing the belt wheel structure.

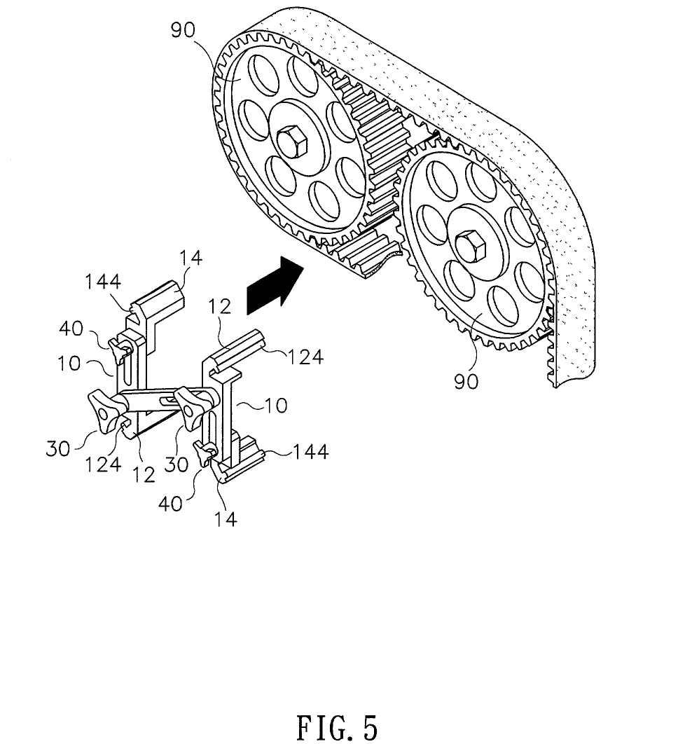

In operation, referring to FIG. 5, the holding device in accordance with the first embodiment of the present invention may be used to hold and secure two belt wheels 90 of the belt wheel structure.

First, each of the two locking members 30 and each of the two securing members 40 are loosened. Then, the holding device may be inserted between the two belt wheels 90 of the belt wheel structure.

The distance and the angle between the two arm plates 10 may be adjusted to fit the relative position of the two belt wheels 90, and each of the two movable snaps 14 may be driven, so as to adjust the distance between each of the two movable snaps 14 and the fixing snap 12 of each of the two arm plates 10, so that the snap tooth 124 of the fixing snap 12 of one of the two arm plates 10 may mate with the snap tooth 144 of one of the two movable snaps 14 to be inserted into the tooth groove of the outer periphery of the two belt wheels 90 of the belt wheel structure for holding and securing the two belt wheels 90 of the belt wheel structure.

Then, each of the two locking members 30 and each of the two securing members 40 may be tightened, so as to secure and position each of the two arm plates 10 and each of the two movable snaps 14, so that the two belt wheels 90 of the belt wheel structure may be secured and positioned by the snap tooth 124 of the fixing snap 12 of one of the two arm plates 10 and the snap tooth 144 of one of the two movable snaps 14, thereby facilitating the user replacing the belt of the belt wheel structure.

Accordingly, in accordance with the holding device of the present invention, the distance and the angle between the two arm plates 10 may be adjusted arbitrarily to fit the relative position of the two belt wheels 90, and the distance and the angle between each of the two movable snaps 14 and the respective fixing snap 12 may also be adjusted arbitrarily, so that the holding device of the present invention may be used to hold and position belt wheel structures of different sizes, types and specifications without having to prepare multiple holders of different sizes, types and specifications, thereby enhancing convenience of operation and maintenance.

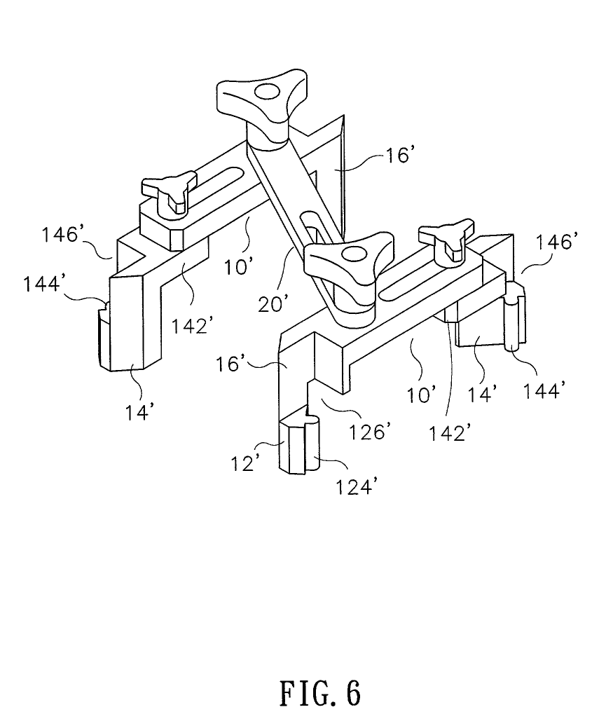

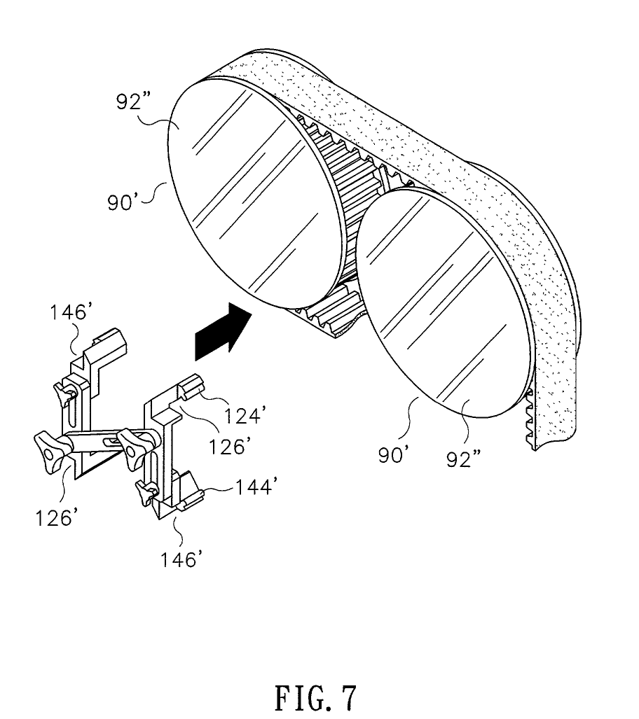

Referring to FIGS. 6 and 7, a holding device of a belt wheel structure in accordance with a second embodiment of the present invention comprises two arm plates 10′, and a connecting member 20′ mounted between the two arm plates 10′. Some of the parts in the second embodiment of the present invention are the same as that in the first embodiment of the present invention, and will not further described in detail.

Each of the two arm plates 10 has a first end provided with a fixing snap 12′, and a second end pivoted with one of two movable snaps 14′. Each of the two movable snaps 14′ is opposite to the fixing snap 12′ of each of the two arm plates 10′. The fixing snap 12′ is integrally connected with each of the two arm plates 10′ by a connecting portion 16′ which has a radial size smaller than that of the fixing snap 12′, so that a first recess 126′ is formed between the snap tooth 124′ of the fixing snap 12′ and the arm 10′. A second recess 146′ is formed between the base portion 142′ and the snap tooth 144′ of the movable snap 14′.

In operation, referring to FIG. 7, the holding device in accordance with the second embodiment of the present invention may be used to hold and secure two belt wheels 90′ of a belt wheel structure that is provided with guard plates 92″.

The first recess 126′ and the second recess 146′ may be used to receive the outer edges of the guard plates 92″, and the snap tooth 124′ may mate with the snap tooth 144′ to be inserted into the tooth groove of the outer periphery of the two belt wheels 90′ of the belt wheel structure for holding and securing the two belt wheels 90′ of the belt wheel structure, without being affected by the guard plates 92″.

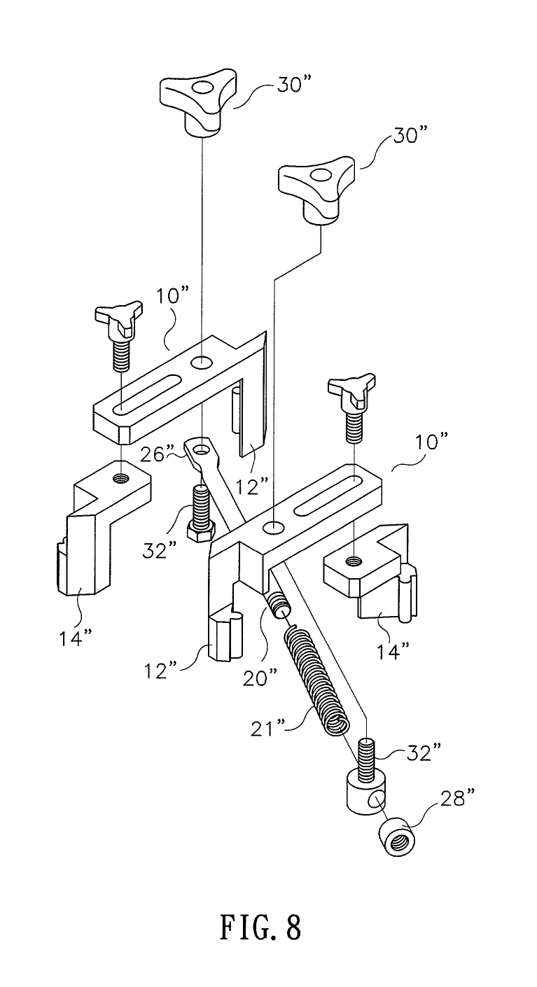

Referring to FIG. 8, a holding device of a belt wheel structure in accordance with a third embodiment of the present invention comprises two arm plates 10″, and a connecting member 20″ mounted between the two arm plates 10″. Some of the parts in the third embodiment of the present invention are the same as that in the second embodiment of the present invention, and will not further described in detail.

The connecting member 20″ is an elongated rod, and has a first end formed with a flat mounting plate 26″ pivotally mounted on a bolt 32″ of a locking member 30″. The connecting member 20″ has a second end extended through a spring 21″ and a bolt 32″ of the other locking member 30″, and screwed with a screw ring 28″. The spring 21″ may provide a pushing action, thereby facilitating adjusting the distance between the arm plates 10″.

In operation, the spring 21″ may provide a pushing action on each of the two arm plates 10″, so that user may directly press the two arm plates 10″ to move toward each other. After the fixing snap 12″ and the movable snap 14″ are inserted between the two opposite belt wheels of the belt wheel structure, the pressing force on the two arm plates 10″ may be removed, so that the two arm plates 10″ may be pushed by the spring 21″ to move outward relative to each other, so that the fixing snap 12″ and the movable snap 14″ may hold and secure the two belt wheels of the belt wheel structure, thereby enhancing the convenience of operation.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A holding device of a belt wheel structure, comprising: two arm plates, and a connecting member mounted between the two arm plates, wherein:
each of the two arm plates is pivoted with the connecting member by one of two locking members, each of the two arm plates has a first end provided with an upright fixing snap vertical to the arm plate, and a second end pivoted with one of two movable snaps by one of two securing members, each of the two movable snaps is opposite to the fixing snap of each of the two arm plates, each of the two movable snaps has a base portion screwed with each of the two securing members, thereby positioning and locking each of the two movable snaps on the respective arm plate, the fixing snap of each of the two arm plates is laterally protruded with a snap tooth, and each of the two movable snaps is laterally protruded with a snap tooth that is opposite to the snap tooth of the fixing snap of each of the two arm plates, so that the snap tooth of the fixing snap of each of the two arm plates may mate with the snap tooth of each of the two movable snaps to be inserted into a belt wheel structure for holding and securing the belt wheel structure.

2. The holding device of a belt wheel structure in accordance with claim 1, wherein each of the two arm plates has a second end axially formed with an elongated slot, one of two securing members has one end extended through the elongated slot of each of the two arm plates, and is pivoted with the base portion of one of two movable snaps

3. The holding device of a belt wheel structure in accordance with claim 1, wherein the connecting member is an elongated plate, and has a first end formed with a bolt hole and a second end axially formed with an elongated slot, each of the two locking members is respectively extended through the bolt hole and the elongated slot of the connecting member, so that the connecting member and the two arm plates may be clamped by each of the two locking members, thereby positioning the connecting member and the two arm plates.

4. The holding device of a belt wheel structure in accordance with claim 1, wherein the each of the two securing members has one end formed with a rotation head which may mate with the base portion of each of the two movable snaps to clamp the respective arm plate, thereby positioning and locking each of the two movable snaps on the respective arm plate.

5. The holding device of a belt wheel structure in accordance with claim 1, wherein a first recess is formed between the snap tooth of the fixing snap and the arm, and a second recess is formed between the base portion and the snap tooth of the movable snap.

6. The holding device of a belt wheel structure in accordance with claim 1, wherein the fixing snap is integrally connected with each of the two arm plates by a connecting portion which has a radial size smaller than that of the fixing snap, thereby forming the first recess.

7. The holding device of a belt wheel structure in accordance with claim 1, wherein the connecting member is mounted with a spring, thereby facilitating adjusting the distance between the arm plates.

8. The holding device of a belt wheel structure in accordance with claim 1, wherein the connecting member is an elongated rod, and has a first end formed with a flat mounting plate pivotally mounted on a bolt of a first locking member, and has a second end extended through a bolt of a second locking member, and screwed with a screw ring, thereby connecting the two arm plates.

9. The holding device of a belt wheel structure in accordance with claim 1, wherein each of the two locking members includes a bolt, and a rotation cap, the bolt is in turn extended through each of the two arm plates and the connecting member, and is screwed with the rotation cap, so that the connecting member and the two arm plates may be clamped by a bolt head of the bolt and the rotation cap of each of the two locking members, thereby positioning the connecting member and the two arm plates.
